(19) United States
(12) Patent Application Publication
(10) Pub. No.: US 2012/0233449 A1
(43) Pub. Date: Sep. 13, 2012

(54) METHODS AND SYSTEMS FOR MEASURING TRUSTWORTHINESS OF A SELF-PROTECTING DRIVE

(76) Inventors: Robert H. THIBADEAU, Pittsburgh, PA (US); Gregory J. KAZMIERCZAK, Belle Mead, NJ (US)

(21) Appl. No.: 13/046,425

(22) Filed: Mar. 11, 2011

(51) Int. Cl. G06F 12/14; G06F 9/00

(52) U.S. Cl. 713/2; 713/189; 713/1

(57) ABSTRACT

A method for measuring the trustworthiness of a self-protecting drive includes receiving a measurement from an element within a transitive chain of trust, processing the received measurement, storing the measurement as a verification value, comparing the verification value with a reference verification value stored on the self-protecting drive, and unlocking at least a portion of the self-protecting drive when the reference verification value corresponds to the verification value. A self-protecting drive includes a boot partition, a trusted partition, a master boot partition, a primary partition, a secondary partition, and a particular table that has a verification platform configuration register and a reference platform configuration register. The primary partition is inaccessible until the self-protecting drive determines that a value stored in the verification platform configuration register corresponds to a value stored in the reference platform configuration register.

### BACKGROUND OF THE INVENTION

1. Field of the Invention

The invention relates generally to implementations of self-protecting drives (“SPD”) and methods for maintaining the security of self-protecting drives without relying on the transitive chain of trust.

2. Description of Related Art

A Trusted Platform Module (“TPM”) is the name of a specification and standard that describes how to measure and verify the trustworthiness of a computing platform, in conjunction with accompanying BIOS code, which may be rooted in the core root of trust for measurement (“CRTM”). The TPM Specification is the work of the Trusted Computing Group (“TCG”), which has created a number of “trusted computing” specifications, including “TCG Storage Architecture Core Specification,” “Storage Work Group Storage Interface Interactions Specification,” “Storage Work Group Storage Security Subsystem Class: Opal,” “Storage Work Group Storage Security Subsystem Class: Enterprise,” and “Storage Work Group Storage Security Subsystem Class: Optical,” each of which are incorporated herein by reference, in their entirety.

Laptops, netbooks, and other computer platforms may contain both TPMs and self-protecting drives (“SPDs”). In a known system, e.g., the system disclosed in Patent Application Publication No. US 2009/0172378 A1, the integration of TPM and SPD functionality utilized a program loaded from the SPD to the pre-OS boot environment to provide integrity services during the boot of a computing platform. Known TPM systems relying on TCG Specifications may be found in Patent Application Publication No. US 2009/0172378 A1, U.S. Pat. Nos. 7,461,270 B2, and 7,426,747 B2, each of which are hereby incorporated by reference in their entirety.

The TPM stores, protects, and reports various measurements of the PC's (“Personal Computer”) integrity. The TPM also generates and stores cryptographic keys (for example, a public/private key pair) that may be used to authenticate those integrity measurements using, for example, digital signature and verification.

According to the standards promulgated by the TCG in the TPM Specification, various metrics may be utilized to characterize the integrity or trustworthiness of a particular PC. For example, every operating system (“OS”) platform includes a set of device drivers, executables, and other software components. A measurement, e.g., a hash digest, of the OS components when the OS is in a trusted state, e.g., a state in which the OS is initially installed on the PC, may function as an integrity metric. A comparison of that trusted measurement with a measurement taken at some later point in time would indicate whether the OS components had been altered or changed in some way. Particularly, any hash digest of the PC's software configuration potentially may be used as a measurement to later verify the integrity of that configuration.

In a known system, e.g., the system disclosed in Patent Application Publication No. US 2009/0172378 A1, the integrity of a PC's computing platform may be verified through the use of a transitive chain of trust. A transitive chain of trust is an iterative process that begins with a root of trust established in the PC that is configured to describe a trustworthy state of a second group of measurement functions. Based on this description, a verifier may determine the level of trust that it will place in this second group of functions. If the verifier determines this second group of functions to have an acceptable level of trustworthiness, then the trust boundary is extended from the root of trust to include the second group of functions. The now-trusted second group of functions may now be utilized to describe a trustworthy state of a third group of functions, which extends the trust boundary to the third group of functions, and so on.

The transitive trust model may be applied to measuring the integrity or trustworthiness of the components of the PC. The TCG's trusted computing standard currently describes two models for measuring the integrity of the components of the PC: static root of trust for measurement (“SRTM”) and dynamic root of trust for measurement (“DRTM”). The SRTM model uses a known starting state, e.g., the PC's power-on BIOS boot block, as a CRTM. Nevertheless, these systems rely on the integrity of the system running before them, and thus may be susceptible to malicious attacks directed at a CRTM.

### SUMMARY OF THE INVENTION

Therefore, a need has arisen for systems and methods for verifying the integrity of storage devices without relying solely on the transitive chain of trust. In an embodiment, the SPD is enhanced with a template, e.g., the “Verifier SP Template” which may be instantiated along with a Locking SP that provides SPD services for self-verifying the TPM environment, including TPM-created PCRs, verification of TPM public key quoting, and TPM device identity as well as TPM-attested individual or domain identity using an Attestation Identity Key (“AIK”). In the invention, additional functions are implemented for ensuring that corruptions of software running in the preboot or OS-present environments do not impact the decisions made by the SPD to unlock itself for normal reading and writing, or the integrity of the TPM attestations to the SPD.

In an embodiment of the invention, the Verifier SP Template also contains methods for the SPD to report out its own internal verification that the firmware and possibly the hardware of the SPD have not been tampered with. This may be done in such a way that the TPM-based measurements can be extended to the firmware and hardware inside the security boundary of the SPD. Moreover, in an embodiment of the invention, the integrity of the pre-boot execution environment also may be evaluated inside the security boundary of the SPD.

In an embodiment of the invention, a method for measuring the trustworthiness of a self-protecting drive comprises receiving a measurement from an element within a transitive chain of trust, processing the received measurement, storing the measurement as a verification value, comparing the verification value with a reference verification value stored on the self-protecting drive, and unlocking at least a portion of the self-protecting drive when the reference verification value corresponds to the verification value.

In another embodiment of the invention, a self-protecting drive comprises a boot partition comprising an alternate master boot record, a trusted partition, a master boot partition comprising a master boot record, a primary partition, a secondary partition, and a particular table comprising a verification platform configuration register and a reference platform configuration register, wherein the primary partition is configured to be inaccessible until the self-protecting drive determines that a value stored in the verification platform configuration register corresponds to a value stored in the reference platform configuration register.

In still another embodiment of the invention, a computer system comprises a BIOS configured to execute a startup procedure and to send a measurement, and a self-protecting drive configured to receive the measurement. The self-protecting drive comprises, a boot partition comprising an alternate master boot record, a trusted partition, a master boot partition comprising a master boot record, a primary partition, a secondary partition, and a particular table comprising a verification platform configuration register configured to store a value generated from the measurement, and a reference platform configuration register configured to store a predetermined value, wherein the primary partition is configured to be locked until the self-protecting drive determines that the generated value stored in the verification platform configuration register corresponds to the predetermined value stored in the reference platform configuration register.

Other objects, features, and advantages of the invention will be apparent to persons of ordinary skill in the art in view of the foregoing detailed description of the invention and the accompanying drawings.

### BRIEF DESCRIPTION OF THE DRAWINGS

For a more complete understanding of the invention, needs satisfied thereby, and the objects, features, and advantages thereof, reference now is made to the following description taken in connection with the accompanying drawings.

FIG. 1 is a block diagram depicting a PC platform in accordance with an illustrative embodiment of the invention.

FIG. 2 is block diagram depicting portions of a trusted hard disk drive in accordance with an illustrative embodiment of the invention; and

FIG. 3A is a flow chart depicting a method for verifying the integrity of a self-protecting drive (“SPD”) without relying on a transitive chain of trust, according to an embodiment of the invention.

FIG. 3B is a continuation of the flowchart depicted in FIG. 3A.

FIG. 4 is an exemplary VerifierInfo table of the Verifier SP stored on the SPD, according to an embodiment of the invention.

FIG. 5 is an exemplary PCR table of the Verifier SP stored on the SPD, according to an embodiment of the invention.

FIG. 6 is a functional diagram of the SPD within a computer system, according to an embodiment of the invention.

### DETAILED DESCRIPTION OF EMBODIMENTS OF THE INVENTION

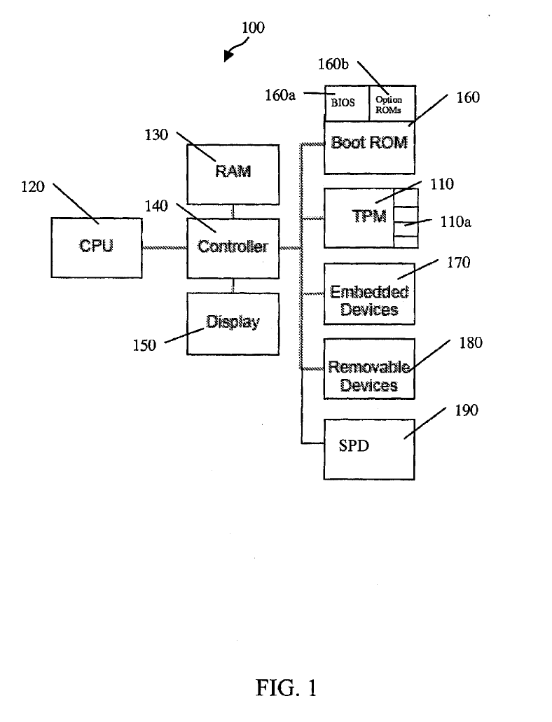

Embodiments of the invention, and their features and advantages, may be understood by referring to FIGS. 1-6, like numerals being used for corresponding parts in the various drawings.

In accordance with an illustrative embodiment of the invention, FIG. 1 is a block diagram depicting a PC platform 100 containing a trusted portion of hardware or software. In one embodiment of the invention, the trusted portion preferably contains a trusted platform module (“TPM”) 110. Nevertheless, the trusted portion may be any other suitable trusted hardware or software, such as, but not limited to, a smart card cryptographically bound to platform 100, or software that is trusted inherently (because it is isolated) or by inference (because it is measured) such as extensible firmware interface (“EFI”) software, system management mode (“SMM”) software, ACPI machine language (“AML”), etc.

PC platform 100 includes a central processing unit (“CPU”) 120 that is directly or indirectly coupled to, for example, a random access memory (“RAM”) 130, a controller 140, and a display 150. Controller 140, which may or may not be integrated into any one of the previously described components, may be directly or indirectly coupled to a boot read-only-memory (“ROM”) 160 and TPM 110. Controller 140 may be further coupled to various embedded devices 170 and/or removable devices 180, and a self-protecting drive (“SPD”) 190. Boot ROM 160 may include a BIOS 160a and may also include one or more Option ROMs or platform extensions 160b. TPM 110 may include one or more shielded memory locations used to protect and report integrity measurements, called platform configuration registers (“PCRs”) 110a.

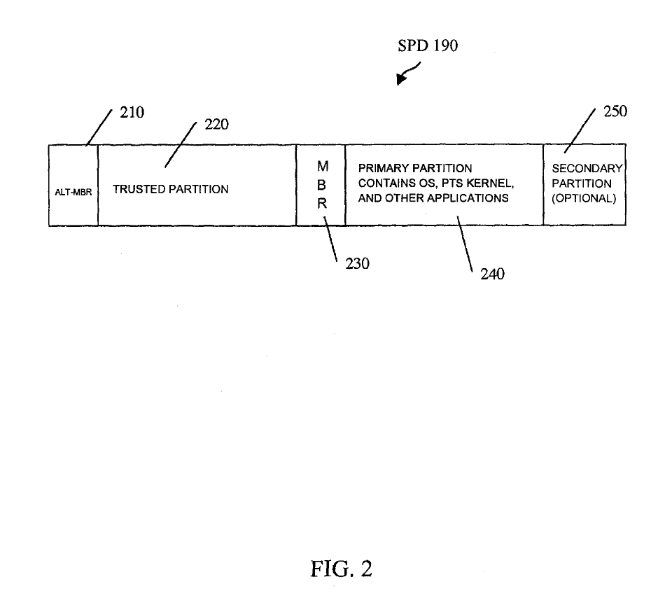

FIG. 2 is a block diagram depicting an exemplary SPD 190 according to an embodiment of the invention. The SPD 190 preferably includes an alternate master boot record (“ALT-MBR”) 210, and a master boot record (“MBR”) 230. MBR 230 is typically the first sector of a data storage device such as a hard disk drive. MBR 230 typically holds, among other things, the disk partition table data. In an embodiment of the invention, ALT-MBR 210 included in SPD 190 is a modified version of a normal MBR that includes additional instructions for ensuring the trustworthiness of the PC platform 100. These additional instructions allow ALT-MBR 210 to measure the MBR 230 using, thus preserving the transitive trust chain. Upon completing execution of ALT-MBR 210, the platform 100 may subsequently execute code in the MBR 230 for the purpose of booting the OS.

SPD 190 may include a primary partition 240, and a trusted partition 220. SPD 190 may also include one or more additional partitions, e.g., a secondary partition 250. Primary partition 240 may store the OS, applications and the Platform Trust Service (“PTS”) kernel.

The PTS is the trusted piece of code which will be relied upon to take measurements of executables and provide integrity reports of those measurements. An integrity report is output from the PTS that contains a TPM 100 signature over PCRs 110a and details of measurements taken by the PTS or input by applications that use the PTS. The integrity report may be used later in verifying the trustworthiness of the PC platform. The PTS kernel is that initial portion of the PTS that is measured prior to the execution of the PTS that extends the transitive trust chain to the entire PTS. Once the PTS kernel has been measured, the PTS may bootstrap itself to execute one or more portions of its code.

The Verifier SP Template will be described with reference to the OPAL 1.0 and Core 1.0 SPD specifications. Nevertheless, the use of these particular SSCs is merely for exemplary purposes. Other existing SSCs, e.g., Enterprise or Optical, could be used in place of the OPAL 1.0 program without an appreciable change to the method and system. Moreover, in an embodiment of the invention, the Verifier SP Template is designed with the TCG Specification. Nevertheless, the invention is not dependent on the TCG specification, which is used merely for exemplary purposes. Any other suitable interface language could be substituted with similar results. In an embodiment of the invention, certain tables from the Core 1.0 Specification are required by the Verifier that are optional in the Opal Specification.

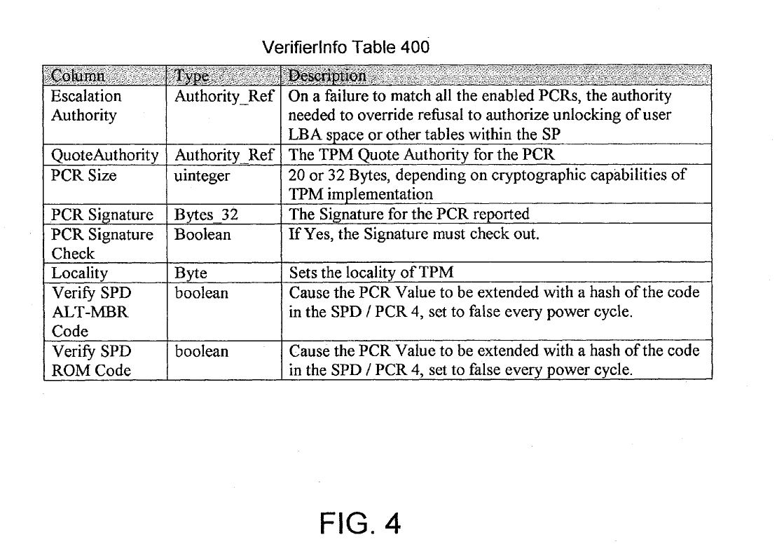

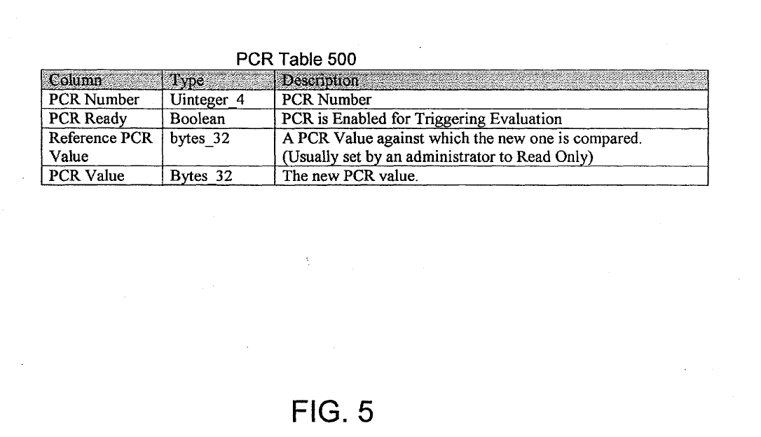

In an embodiment of the invention, the Verifier SP Template enhances the Opal Locking SP with a set of tables. These tables include TPM Quoted PCR values that can be read and written, and that define the state of the Verifier Functions. Specifically, an embodiment of the invention uses at least two new tables. These tables are VerifierInfo Table and PCR Table. These tables are illustrated in FIGS. 4 and 5, respectively, and will be discussed in more detail herein.

Trusted partition 220 of SPD 190 may store one or more computer programs that are accessible only when PC platform 100 executes a boot process. Upon completion of execution of the program or programs in trusted partition 220, SPD 190 may disable all access to trusted partition 220. This disabling of access to trusted partition 220 may occur prior to the execution of code in primary partition 240.

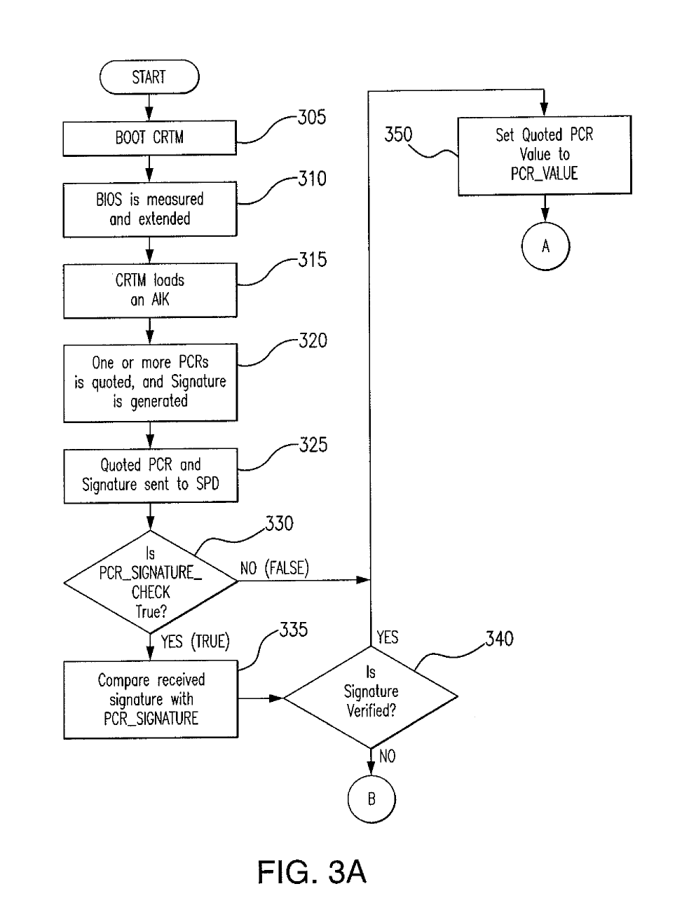

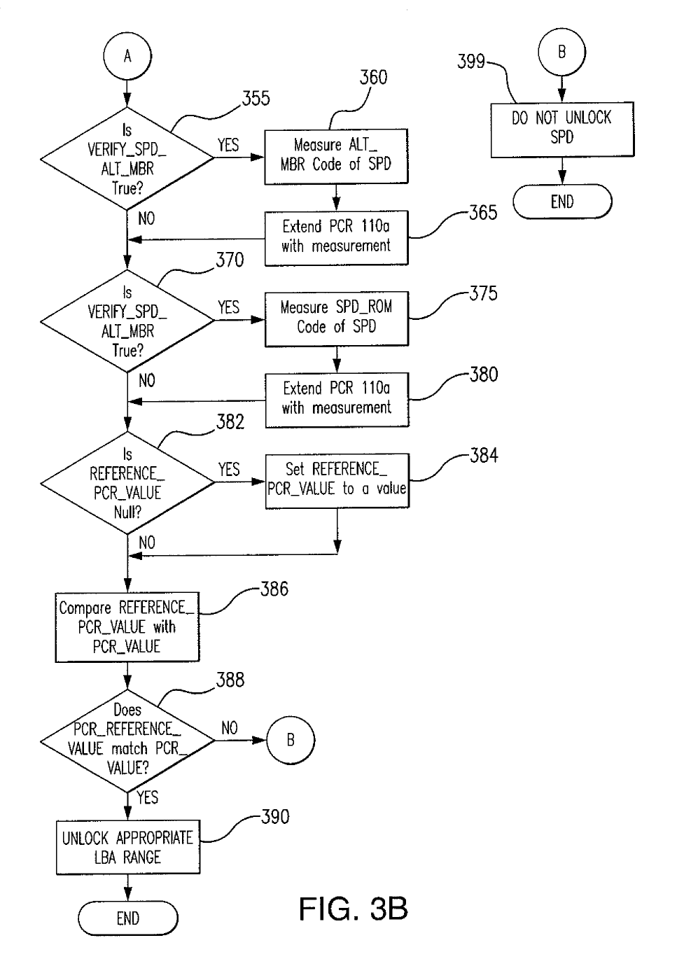

FIG. 3A is a flowchart depicting a method for self-verification of an SPD, e.g., SPD 190. The verification process relies upon a transitive chain of trust until the point at which the SPD 190 is accessed. In an embodiment, SPD 190 measures its own firmware, including its own Boot ROM, in order to ensure that the SPD 190 has not been tampered with. The integrity of the preboot decision environment, rooted by transitive trust, is not factored into the unlock decision made by the SPD.

At Step S305, PC platform 100 boots the CRTM, which as was previously explained is the core trusted root for measurement of integrity, i.e. trustworthiness. At Step S310, CRTM “measures” PC platform's 100 BIOS 160a and extends the value of that measurement into a PCR 110a in TPM 110. As was previously noted, a measurement of any particular component may, in an embodiment of invention, be a hash digest of that component. While the measurement is preferably a hash digest, it need not be, and may instead take the form of any verifiable measurement, including encryption/decryption, digital signatures, and the like. Moreover, as an alternative embodiment, where an extensible firmware interface (“EFI”) is used instead of a conventional BIOS, then at Step S310, PC platform's EFI may be measured. One of ordinary skill in the art will readily appreciate that the invention may operate on platforms utilizing EFI instead of a conventional BIOS without substantial modification.

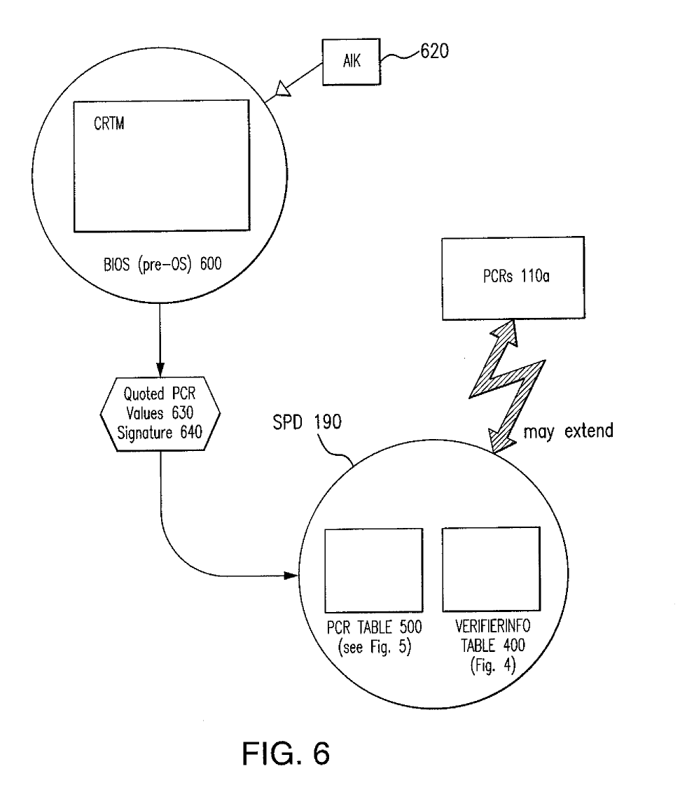

At Step S315, the CRTM retrieves an Application Identity Key (“AIK”) 620 for quoting the PCRs 110a. Referring now to FIG. 6, once the AIK 620 is retrieved and loaded by the CRTM, then at Step S320, the CRTM quotes the PCRs 110a, creating a verification value, e.g., a Quoted PCR Value 630 and a TPM Signature 640. In an embodiment of the invention, Quoted PCR Value 630 may be only one PCR value, but in other embodiments, Quoted PCR Value 630 may represent multiple Quoted PCR Values, depending on the needs of the particular SPD 190 and the implementation of TPM 110. At Step S325, the Quoted PCR Value 630 and TPM Signature 640 are then transmitted to the SPD 190, as shown in FIG. 6. SPD 190 receives the Quoted PCR Value 630 and TPM Signature 640, as shown in FIG. 6.

Referring again to FIG. 3A, if, in VerifierInfo Table 400, the value of PCR_Signature_Check (shown in FIG. 4) is TRUE, e.g., “YES” at Step S330, then at Step S335, the SPD 190 may verify the TPM Signature 640. Specifically, in an embodiment of the invention, the SPD 190 may merely check the value of TPM Signature 640 by checking values. In an embodiment of the invention, this functionality may be disabled if, in VerifierInfo Table 400, the value of PCR_Signature_Check (shown in FIG. 4) is FALSE, e.g., “NO” at Step S330. SPD 190 also may check the value of TPM Signature 640 by verifying the TPM Signature 640 using PCR_Signature from VerifierInfo Table 400 as storage for the received TPM Signature, using any one of techniques for verifying a PCR signature available to those of ordinary skill in the art, e.g., techniques outlined in OPAL 1.0 and CORE 1.0 SPD specifications, or in other SSCs. If the signature is not verified, e.g., “NO” at Step S340, then processing moves to Step S399, the SPD 190 remains locked, and processing at the SPD 190 ends. If the signature is verified, e.g., “YES” at Step S340, then processing moves to Step S350. At Step S350, a SET command is issued to the PCR_Value field of the PCR Table shown in FIG. 5. At this point, the set PCR Value may not yet match the Reference PCR Value, because in an embodiment of the invention, the Reference PCR Value also may be extended based on a hash of the code in the SPD 190, specifically in the ALT-MBR section 210 of the SPD 190.

Referring now to FIG. 3B, after the PCR_Value field of the PCR Table is set, then at Step S355, the SPD checks the value of Verify_SPD_ALT-MBR_Code of the VerifierInfo Table. If the value of Verify_SPD_ALT-MBR_Code is TRUE, e.g., “YES” at Step S355, then at Step S360, the SPD 190 measures its ALT-MBR code in section 210 (as shown in FIG. 2), and at Step S365 the SPD 190 issues a command to extend at least one of the PCRs 110a of the TPM. In an embodiment of the invention, the entire ALT-MBR code in section 210 of SPD 190 may be measured to generate the hash value for extending the at least one of the PCRs 110a. In another embodiment of the invention, an initial, smaller portion of the code in ALT-MBR section 210 may be used to generate the hash value. In an embodiment of the invention, when the value of PCR 110a is extended, then the Reference PCR Value of the SPD 190 also may be extended, depending on the authority level of the PCR 110a that is updated. Processing then moves to Step S370. If the Verify_SPD_ALT-MBR_Code is set to FALSE, e.g., “NO” at Step S355, then processing moves to Step S370.

At Step S370, the SPD checks the value of Verify_SPD_ROM_Code of the VerifierInfo Table. If the value of Verify_SPD_ROM_Code is TRUE, e.g., “YES” at Step S370, then at Step S375, the SPD 190 measures its ROM code, and at Step S380, the SPD 190 issues a command to extend at least one of the PCRs 110a of the TPM. In an embodiment of the invention, it is PCR #4 of the PCRs 110a. Similarly to above, in an embodiment of the invention, when the value of PCR 110a is extended, then the Reference PCR Value of the SPD 190 also may be extended, depending on the authority level of the PCR 110a that is updated. Processing then moves to Step S382. If the Verify_SPD_ROM_Code is set to FALSE, e.g., “NO” at Step S370, then processing moves to Step S382.

At Step S382, the SPD 190 checks to determine if the current value of the Reference_PCR_Value field is 0 or null. If the Reference_PCR_Value field is 0 or null, e.g., “YES” at Step S382, then at Step S384, the Reference_PCR_Value field is set. Depending on the configuration of SPD 190, the Reference_PCR_Value may be set by a PUT command from an external application or device, or the Reference_PCR_Value may be internally computed, i.e., by the firmware of the SPD 190. Moreover, the Reference_PCR_Value may be computed by both internal and external calculations, e.g., as an extension of an existing PCR value modified by the measurement of the SPD 190's firmware. When the Reference_PCR_Value is set, processing moves to Step S386. If the Reference_PCR_Value previously has been set, e.g., “NO” at Step S382, then processing moves immediately to Step S386.

At Step S386, the Reference_PCR_Value is compared with the PCR_Value, to determine whether to unlock a specific Logical Block Address (“LBA”) of the SPD 190. If the Reference_PCR_Value matches the PCR_Value, e.g., “YES” at Step S388, then at Step S390, the appropriate LBA range is unlocked. In an embodiment of the invention, depending on the result of the comparison, different LBAs of the SPD 190 may be unlocked depending on the type of match between the Reference_PCR_Value and the PCR_Value. In another embodiment of the invention, each match of the Reference_PCR_Value and the PCR_Value may cause the entire writeable portion of the SPD 190 to be unlocked. After the specific LBA of the SPD 190 is unlocked, processing ends. If the Reference_PCR_Value does not match the PCR_Value, e.g., “NO” at Step S388, then processing moves to Step S399, no portion of the SPD 190 is unlocked, and processing ends.

FIGS. 4 and 5 show tables used to implement the Verifier SP in an exemplary embodiment of the invention. These tables are meant to be merely exemplary, and are not intended to limit the Verifier SP to these specific implementations. Depending on the particular application of the SPD, more or fewer fields of each table may be implemented.

FIG. 4 shows an exemplary VerifierInfo Table. The first field is Escalation_Authority, which is of the type Authority_Ref. The Authority_Ref is a reference to an authority table. In an embodiment of the invention, e.g., in which OPAL 1.0 is used to implement the TPM, the authority table is of type Authority in the Locking SP, described on Page 59 of the TCG Storage SSC: Opal Specification Version 1.00, Revision 3.00, incorporated herein by reference in its entirety. The Escalation_Authority field of the VerifierInfo Table specifies the authority level required to override the decision made by the SPD 190 not to unlock specific LBAs on a failure to match some or all of the enabled PCRs. In other words, a user having an authority higher than or equal to the authority referenced in the Escalation_Authority field may authorize the SPD 190 to unlock LBA space regardless of whether the PCR_Value and the PCR_Reference_Values match, as described above. Similarly, the VerifierInfo table also contains a QuoteAuthority field, which is also of type Authority_ref. This value represents the minimum authority for quoting the PCR values from PCRs 110a of the TPM 110. If the requestor does not have sufficient authority to quote the PCR values from the TPM 110, then the SPD 190 may be operating in an untrustworthy environment, and the SPD 190 will not unlock.

VerifierInfo includes a PCR Size field, which designates the size of the PCR or PCRs stored in the PCR Table 500. This size varies based on the encryption method used by the TPM, i.e., if 2048-bit RSA encryption is used, then the size may be 32 bytes. Generally, the size is either 20 bytes or 32 bytes, although other sizes may be used in other embodiments, depending on the implementation of the SPD. VerifierInfo also includes a PCR_Signature field. As described above with respect to Step S335, the TPM Signature sent to the SPD is stored in this field. The next field in VerifierInfo, PCR_Signature_Check, is a boolean. If this field evaluates to “TRUE,” then the signature stored in PCR_Signature is verified. If this field evaluates to “FALSE,” then the signature stored in PCR_Signature is not checked. VerifierInfo also includes a Locality field, which is a byte-sized field that indicates the locality of the TPM 110 (e.g., BIOS, a different SPD).

VerifierInfo finally includes two boolean fields, Verify_SPD_ALT-MBR_Code, and Verify_SPD_ROM_Code. These two boolean fields, when evaluated to “TRUE” indicate that the PCR 110a should be extended with the SPD 190's ALT-MBR and ROM, respectively.

FIG. 5 shows an exemplary PCR Table. The first field is PCR Number, which is an unsigned integer indicating which enumerated PCR corresponds to the information stored in the table. The second field is PCR_Ready, which is a boolean indicating whether the PCR is enabled for triggering evaluation, i.e., this value is false if the PCR must continue to be extended. The third and fourth fields are Reference_PCR_Value and PCR_Value, which are used to compare PCR values for unlocking SPD 190, and which are discussed in detail above with respect to FIGS. 3A and 3B.

In an embodiment of the invention, the TPM Version 1.2 specification includes the C_RSA_{—}2048 table, which provides 2048-bit encryption for use by the Verifier SP. This permits the definition of an Authority in the Authority table with sufficient privileges to perform the Public Key Verification, which may be used to quote the PCR values protected by the TPM 110, as previously described with respect to Step S320 of FIG. 3A. Nevertheless, if these tables are not present in the underlying TPM specification, then the Verifier SP may supply these tables, which enable 2048-bit RSA encryption, as understood by one of ordinary skill in the art.

FIG. 6 shows a functional diagram of a system using an SPD 190 according to an embodiment of the invention. As shown in the functional diagram, PCR Table 500 and VerifierInfo Table 400 are stored in the SPD 190, which receives Quoted PCR Value 630 and TPM Signature 640 from the CRTM. Moreover, the SPD 190 may retrieve and update or extend PCRs 110a, if that functionality is enabled.

While the invention has been described in connection with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. The specification and the described examples are considered as exemplary only, with the true scope and spirit of the invention indicated by the following claims.

What is claimed is:

1. A method for measuring the trustworthiness of a self-protecting drive, the method comprising:
receiving a measurement from an element within a transitive chain of trust;
processing the received measurement;
storing the measurement as a verification value;
comparing the verification value with a reference verification value stored on the self-protecting drive; and
unlocking at least a portion of the self-protecting drive when the reference verification value corresponds to the verification value.

2. The method of claim 1, further comprising:
measuring at least one characteristic of the self-protecting drive; and
extending the measurement received from the element based on the at least one characteristic of the self-protecting drive.

3. The method of claim 2, further comprising, one or more further self-protecting drives operatively connected to the self-protecting drive, wherein the extended measurement is used as a further reference verification value in at least one of the one or more further self-protecting drives.

4. The method of claim 2, wherein the at least one characteristic of the self-protecting drive comprises:
a first characteristic corresponding to information in a read-only memory of the self-protecting drive; and
a second characteristic corresponding to information in an alternate boot record of the self-protecting drive.

5. The method of claim 1, wherein the measurement comprises:
at least one value from a platform configuration register; and
a signature obtained by applying an attestation identity key to the platform configuration register, wherein the step of processing the received measurement comprises:
storing the signature in a table;
verifying whether the stored signature is a trusted signature; and
storing the at least one value as the verification value.

6. The method of claim 4, wherein when the stored signature is not verified as the trusted signature, the self-protecting drive remains locked regardless of whether the reference verification value corresponds to the verification value.

7. The method of claim 1, wherein when the reference verification value is null, generating the reference verification value based on at least one of an external set command and a property of at least a portion of the self-protecting drive.

8. The method of claim 1, wherein the verification value and the reference verification value are platform configuration registers.

9. A self-protecting drive comprising:
a boot partition comprising an alternate master boot record;
a trusted partition;
a master boot partition comprising a master boot record;
a primary partition;
a secondary partition; and
a particular table comprising a verification platform configuration register and a reference platform configuration register,
wherein the primary partition is configured to be inaccessible until the self-protecting drive determines that a value stored in the verification platform configuration register corresponds to a value stored in the reference platform configuration register.

10. The self-protecting drive of claim 9, further comprising:
a further table comprising a signature portion, wherein the further table is configured to receive a signature portion from a trusted component, and verify an authority of the signature prior to determining whether the value stored in the verification platform configuration register corresponds to the value stored in the reference platform configuration register.

11. The self-protecting drive of claim 10, wherein the further table comprises a particular authority value, wherein when the particular authority value is greater than a predetermined override authority value, the self-protecting drive may be unlocked regardless of the comparison between the value stored in the verification platform configuration register and the value stored in the reference platform configuration register.

12. The self-protecting drive of claim 10, wherein the further table comprises a further authority value, wherein the further authority value corresponds to a minimum authority for allowing access to the platform configuration registers.

13. The self-protecting drive of claim 10, wherein the further table comprises a size field that determines the size of the platform configuration registers.

14. The self-protecting drive of claim 10, wherein the particular table and the further table are stored in the boot partition.

15. The self-protecting drive of claim 9, wherein the particular table further comprises an identifying number that uniquely identifies the platform configuration register values stored in the particular table.

16. A computer system comprising:
a BIOS configured to execute a startup procedure and to send a measurement; and
a self-protecting drive configured to receive the measurement, the self-protecting drive comprising:
a boot partition comprising an alternate master boot record;
a trusted partition;
a master boot partition comprising a master boot record;
a primary partition;
a secondary partition; and
a particular table comprising:
a verification platform configuration register configured to store a value generated from the measurement; and
a reference platform configuration register configured to store a predetermined value,
wherein the primary partition is configured to be locked until the self-protecting drive determines that the generated value stored in the verification platform configuration register corresponds to the predetermined value stored in the reference platform configuration register.

17. The computer system of claim 16, wherein the measurement is generated by the BIOS and the measurement comprises at least one platform configuration register and a signature, and
wherein the self-protecting drive is configured to verify the signature prior to determining whether the generated value stored in the verification platform configuration register corresponds to the predetermined value stored in the reference platform configuration register.
